(19) United States
(12) Patent Application Publication
(10) Pub. No.: US 2015/0215357 A1
(43) Pub. Date: Jul. 30, 2015

(54) VIDEO PLAYING METHOD AND APPARATUS

(71) Applicant: Tencent Technology (Shenzhen) Company Limited, Shenzhen (CN)

(72) Inventor: Yisha LU, Shenzhen (CN)

(21) Appl. No.: 14/682,029

(22) Filed: Apr. 8, 2015

Related U.S. Application Data
(63) Continuation of application No. PCT/CN2013/084466, filed on Sep. 27, 2013.

(30) Foreign Application Priority Data
Oct. 9, 2012 (CN) 201210378704.3

(51) Int. Cl. H04L 29/06; H04N 21/433; H04L 29/08

(52) U.S. Cl. CPC H04L 65/4084; H04L 65/1083; H04L 67/02; H04N 21/4333

(57) ABSTRACT

A client of a first terminal device enables a user to log on the client of the first terminal device with a user account of the client of the first terminal device, and plays, in a video playing window, a video of video website selected by the user. When obtaining a terminating operation performed for the video by the user, the client of the first terminal device saves the user account as well as a playing address and playing process of the video. A client of a second terminal device enables the user to log on the client of the second terminal device with the user account, and obtains the saved playing address and playing process according to the user account. The client of the second terminal device continues to play the video in the video playing window according to the playing address and the playing process.

### CROSS-REFERENCE TO RELATED APPLICATIONS

This application is a continuation of International Application No. PCT/CN2013/084466, filed on Sep. 27, 2013, which claims the benefit and priority of Chinese Patent Application No. 201210378704.3, filed Oct. 9, 2012. The entire disclosures of each of the above applications are incorporated herein by reference.

### TECHNICAL FIELD

The present invention relates to network communication technologies, and more particularly to a video playing method and apparatus.

### BACKGROUND

With the development of various video playing terminal devices and the increase of radio network coverage, more and more users would like to play videos through various terminal devices on various occasions. When viewing videos on a terminal device, a user may hope to save a video that interests the user or has not finished, so as to continue the video next time.

In order to make the user continue to play the video that interests the user or has not finished, the user may obtain a register account from a video website. Specifically, the user may log on the video website with the register account, and then view videos of the video website. If a video interests the user or has not finished, the user may collect the video or save the playing progress of the video. When logging on the video website with the register account next time, the user may view the collected video again or continue to view the video from a time point corresponding to the playing progress.

However, if the user views a video of a certain video website but does not log on the video website, the video website may save the playing progress of the video viewed by the user locally. That is, the playing progress of the video may be saved on a terminal device currently used by the user. In this case, if the user wants to continue to view the video next time, the user can view the video only through the terminal device used last time. If the user logs on a video website with a register account of the video website and views a video of the video website, the video website may save the playing progress of the video viewed by the user on a device at the network side. If the user wants to continue to view the video through another terminal device next time, the user may log on the video website again with the register account, and then view the video. In this case, videos that can be collected or saved by the user all belong to the video website, and videos of other video websites cannot be collected or saved by the user. That is, the videos collected or saved by the user depend on the video website. If the user wants to collect or save videos of other video websites, the user must log on other video websites, which makes the user inconvenient.

### SUMMARY OF THE INVENTION

Embodiments of the present invention provide a video playing method and apparatus. The solution provided by the embodiments of the present invention is implemented as follows.

The video playing method includes:

enabling, by a client of a first terminal device, a user to log on the client of the first terminal device with a user account of the client of the first terminal device, and playing, in a video playing window, a video of a video website selected by the user;

when obtaining a terminating operation performed for the video by the user, saving, by the client of the first terminal device, the user account of the client of the first terminal device as well as a playing address and playing process of the video;

enabling, by a client of a second terminal device, the user to log on the client of the second terminal device with the user account of the client of the first terminal device, and obtaining the playing address and playing process of the video saved by the client of the first terminal device according to the user account of the client of the first terminal device; and

continuing, by the client of the second terminal device, to play the video in the video playing window according to the playing address and playing process of the video.

A video playing apparatus includes a first logging module, a saving module, a second logging module and a playing module, wherein

the first logging module is configured to enable a user to log on a client of a first terminal device with a user account of the client of the first terminal device, and play, in a video playing window, a video of a video website selected by the user.

the saving module is configured to, when obtaining a terminating operation performed for the video by the user, save the user account of the client of the first terminal device as well as a playing address and playing process of the video;

a second logging module is configure to enable the user to log on a client of a second terminal device with the user account of the client of the first terminal device, and obtain the playing address and play process of the video saved by the client of the first terminal device according to the user account of the client of the first terminal device; and

a playing module is configured to continue to play the video in the video playing window according to the playing address and playing process of the video.

As can be seen from the solution provided by the embodiments of the present invention, the playing address and playing progress of the video are saved by the client of the first terminal device, and thus the client of the second terminal device may continue to play the video according to the playing address and playing progress of the video after the user logs on the client of the second terminal device with the user account of the client of the first terminal device. In this way, the video collected or saved through a terminal device can be played through another terminal device. Accordingly, the user may view the video of any video website through different terminal devices, thereby improving the experiences of the user.

### BRIEF DESCRIPTION OF DRAWINGS

In order to describe the solution provided by the embodiments of the present invention clearly, the accompanying drawings referred to in the embodiments are illustrated briefly hereinafter. Obviously, these accompanying drawings are some examples of the present invention, and according to these accompanying drawings, those skilled in the art can obtain other accompanying drawings without creative labor.

FIG. 1 is a schematic diagram illustrating a video playing method according to an embodiment of the present invention.

FIG. 2 is a schematic diagram illustrating a video playing method according to another embodiment of the present invention.

FIG. 3 is a schematic diagram illustrating the structure of a video playing apparatus according to an embodiment of the present invention.

FIG. 4 is a schematic diagram illustrating the structure of a first logging module shown in FIG. 3 according to an embodiment of the present invention.

FIG. 5 is a schematic diagram illustrating the structure of a video playing apparatus according to another embodiment of the present invention.

FIG. 6 is a schematic diagram illustrating the structure of a collecting module shown in FIG. 5 according to an embodiment of the present invention.

FIG. 7 is a schematic diagram illustrating the structure of a collecting module shown in FIG. 5 according to another embodiment of the present invention.

FIG. 8 is a schematic diagram illustrating the structure of a second logging module shown in FIG. 3 according to an embodiment of the present invention.

FIG. 9 is a schematic diagram illustrating the structure of a video playing apparatus according to another embodiment of the present invention.

### DETAILED DESCRIPTION

For simplicity and illustrative purposes, the present invention is described by referring mainly to an embodiment thereof. In the following description, numerous specific details are set forth in order to provide a thorough understanding of the present invention. It will be readily apparent however, that the present invention may be practiced without limitation to these specific details. In other instances, some methods and structures have not been described in detail so as not to unnecessarily obscure the present invention. As used herein, the term “includes” means includes but not limited to.

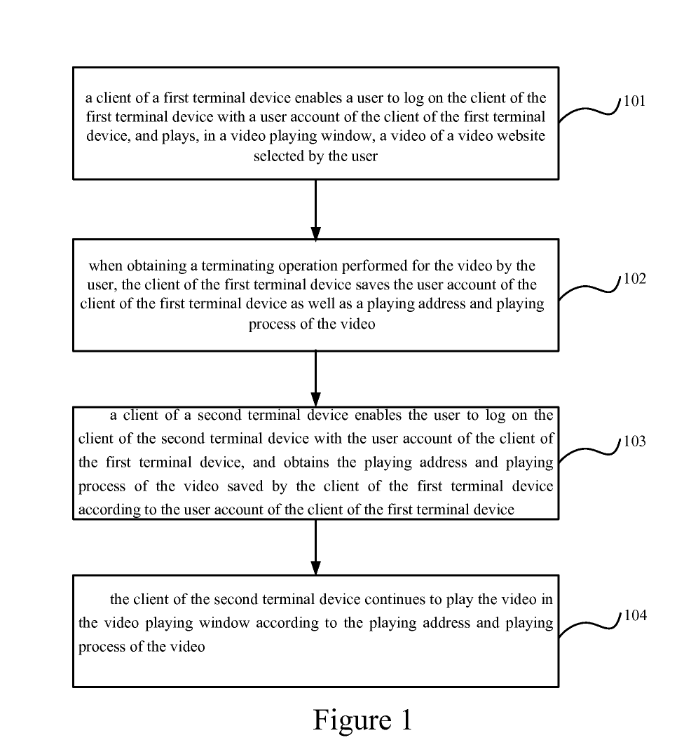

FIG. 1 is a schematic diagram illustrating a video playing method according to an embodiment of the present invention. As shown in FIG. 1, the method includes following blocks.

At block 101, a client of a first terminal device enables a user to log on the client of the first terminal device with a user account of the client of the first terminal device, and plays, in a video playing window, a video of a video website selected by the user.

At block 102, when obtaining a terminating operation performed for the video by the user, the client of the first terminal device saves the user account of the client of the first terminal device as well as a playing address and playing process of the video.

At block 103, a client of a second terminal device enables the user to log on the client of the second terminal device with the user account of the client of the first terminal device, and obtains the playing address and playing process of the video saved by the client of the first terminal device according to the user account of the client of the first terminal device.

At block 104, the client of the second terminal device continues to play the video in the video playing window according to the playing address and playing process of the video.

The client of the first terminal device is a browser or a browser plug-in. If the client of the first terminal device is a browser, the client of the second terminal device also is a browser. If the client of the first terminal device is a browser plug-in, the client of the second terminal device also is a browser plug-in.

In an example, if the client of the first terminal device is a browser, the process that the client of the first terminal device enables the user to log on the client of the first terminal device with the user account of the client of the first terminal device, and plays, in the video playing window, the video of the video website selected by the user includes:

the browser of the first terminal device creating the video playing window, enabling the user to log on the browser of the first terminal device with the user account of the browser of the first terminal device, and playing, in the video playing window, the video of the video website selected by the user from a webpage displayed by the browser of the first terminal device.

In an example, if the client of the first terminal device is a browser plug-in, the process that the client of the first terminal device enables the user to log on the client of the first terminal device with the user account of the client of the first terminal device, and plays, in the video playing window, the video of the video website selected by the user includes:

the browser plug-in of the first terminal device creating the video playing window through the browser of the first terminal device, enabling the user to log on the browser plug-in of the first terminal device with the user account of the browser plug-in of the first terminal device, and after communicating with the browser of the first terminal device, playing, in the video playing window through the browser of the first terminal device, the video of the video website selected by the user from a webpage displayed by the browser of the first terminal device.

In an example, the client of the first terminal device may save the user account of the client of the first terminal device as well as a playing address and playing process of the video at cloud.

In an example, after the client of the first terminal device saves the user account of the client of the first terminal device as well as a playing address and playing process of the video, the method further includes:

the client of the first terminal device saving the playing address of the video into a user collecting list. The user collecting list saves playing addresses of all videos viewed by the user.

After the client of the first terminal device saves the playing address of the video into the user collecting list, the method further includes:

the client of the first terminal device obtaining an editing operation performed for the user collecting list by the user, and saving the use collecting list again after the editing operation is performed. The editing operation includes at least one of adding a playing address, deleting a playing address, modifying a playing address and clearing the user collecting list.

After the client of the first terminal device saves the playing address of the video into the user collecting list, the method further includes:

the client of the first terminal device obtaining a sharing operation of the user performed for the user collecting list, and sharing a playing address of a video selected by the user through the sharing operation with another user.

In an example, after the client of the second terminal device continues to play the video in the video playing window according to the playing address and playing process of the video, the method further includes:

the client of the second terminal device saving the playing address of the video into the user collecting list. The user collecting list saves playing addresses of all videos viewed by the user.

After the client of the second terminal device saves the playing address of the video into the user collecting list, the method further includes:

the client of the second terminal device obtaining an editing operation performed for the user collecting list by the user, and saving the use collecting list again after the editing operation is performed. The editing operation includes at least one of adding a playing address, deleting a playing address, modifying a playing address and clearing the user collecting list.

After the client of the second terminal device saves the playing address of the video into the user collecting list, the method further includes:

the client of the second terminal device obtaining a sharing operation of the user performed for the user collecting list, and sharing a playing address of a video selected by the user through the sharing operation with another user.

In an example, the terminating operation described in block 102 at least includes an operation of quitting the video playing window.

In an example, when obtaining the operation of quitting the video playing window, the client of the first terminal device saves the user account of the client of the first terminal device as well as the playing address and playing process of the video.

As can be seen from the method provided by the embodiments of the present invention, the playing address and playing progress of the video are saved by the client of the first terminal device, and thus the client of the second terminal device may continue to play the video according to the playing address and playing progress of the video after the user logs on the client of the second terminal device with the user account of the client of the first terminal device. In this way, the video collected or saved through a terminal device can be played through another terminal device. Accordingly, the user may view the video of any video website through different terminal devices, thereby improving the experiences of the user.

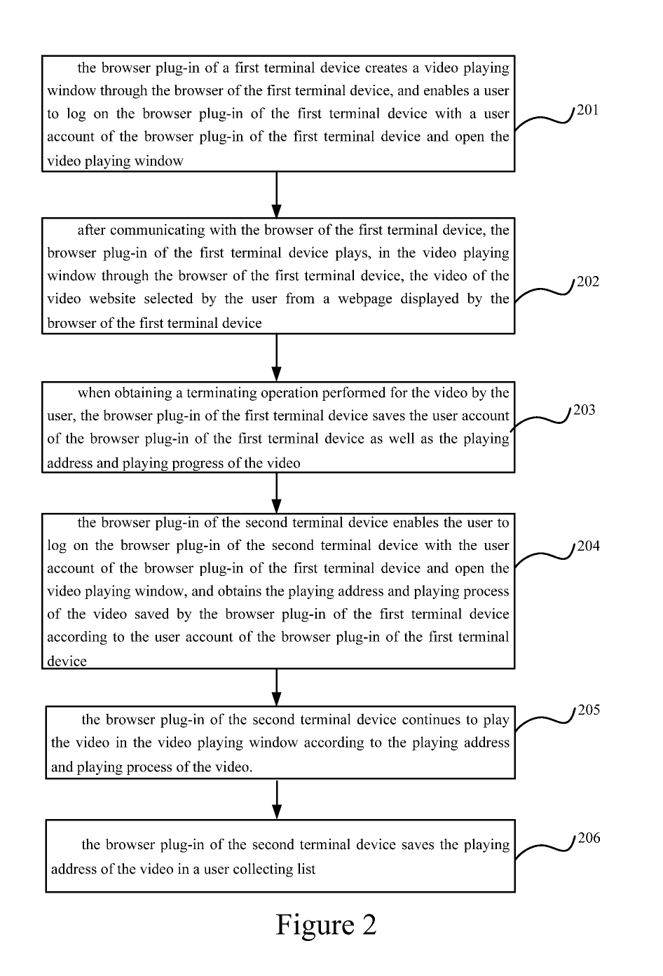

FIG. 2 is a schematic diagram illustrating a video playing method according to another embodiment of the present invention. The method includes following blocks.

At block 201, the browser plug-in of a first terminal device creates a video playing window through the browser of the first terminal device, and enables a user to log on the browser plug-in of the first terminal device with a user account of the browser plug-in of the first terminal device and open the video playing window.

In this block, the video playing window may be created by the browser of the first terminal device after the browser plug-in of the first terminal device communicates with the browser of the first terminal device, or may be created by the browser plug-in of the first terminal device after the browser of the first terminal device gives a creating function to the browser plug-in of the first terminal device. The user may register on the browser plug-in of the first terminal device to obtain the user account of the browser plug-in. After the user registers, the user may log on the browser plug-in with the user account of the browser plug-in. In an example, the video playing window created by the browser plug-in of the first terminal device or created by the browser plug-in through the browser of the first terminal device is associated with a background server, and applicable to various browsers. Accordingly, the video playing window may be run on clients of different platforms. The video playing window is independent on the browser relatively, and may be opened after the user logs on the browser plug-in with the user account of the browser plug-in. In an example, the video playing window may be displayed on the browser in the form of icon. When the user clicks the icon, an interface of the video playing window may be displayed.

In another example, the video playing window may also be created by the browser of the first terminal device, and the browser of the first terminal device enables the user to log on the browser of the first terminal device with the user account of the browser of the first terminal device and open the video playing window. Accordingly, block 201 may be replaced with this process. However, the video playing window created by the browser of the first terminal device can only be applied to the same type of browsers of different terminal devices.

The method for creating the video playing window is not limited in the embodiments of the present invention. In an example, a video playing window in a webpage displayed by the browser may also be used to play a video selected by the user. In this case, the user is required to register on the browser or the browser plug-in to obtain a user account, thereby saving the playing address and playing progress of the video.

The first terminal device in the embodiments of the present invention may be a personal computer, a mobile phone or any mobile terminal device, which is not limited herein.

At block 202, after communicating with the browser of the first terminal device, the browser plug-in of the first terminal device plays, in the video playing window through the browser of the first terminal device, the video of the video website selected by the user from a webpage displayed by the browser of the first terminal device.

In an example, when selecting a video of a video website, the user may click a playing address corresponding to the video, obtain the data of the selected video from the video website, and play the video in the video playing window. In an example, the playing address of the video may be a URL of the video website.

In another example, the browser of the first terminal device may play, in the video playing window, the video of the video website selected by the user from a webpage displayed by the browser of the first terminal device. Accordingly, block 202 may be replaced with this process.

At block 203, when obtaining a terminating operation performed for the video by the user, the browser plug-in of the first terminal device saves the user account of the browser plug-in of the first terminal device as well as the playing address and playing progress of the video.

In an example, the terminating operation at least includes an operation of quitting the video playing window. When obtaining the operation of quitting the video playing window, the browser plug-in of the first terminal device saves the user account of the browser plug-in of the first terminal device as well as the playing address and playing progress of the video. In another example, the terminating operation may be a pause operation, which is not limited herein.

In another example, if the video is played by the browser of the first terminal device, block 203 is performed by the browser of the first terminal device.

Herein, the playing address of the video saved by the browser plug-in of the first terminal device may be an external link address of the video, such as the URL of the video website. The video may be found according to the playing address, and may be obtained from the playing address. The playing progress of the video is a time point at which the user performs the terminating operation for the video. The playing address and playing progress of the video may be saved at cloud or a background server, and the user account of the browser plug-in of the first terminal device may also be saved at the cloud or the background server.

In an example, after the browser plug-in of the first terminal device saves the user account of the browser plug-in of the first terminal device as well as a playing address and playing process of the video, the method further includes:

the browser plug-in of the first terminal device saving the playing address of the video into a user collecting list. The user collecting list saves playing addresses of all videos viewed by the user.

After the browser plug-in of the first terminal device saves the playing address of the video into the user collecting list, the method further includes:

the browser plug-in of the first terminal device obtaining an editing operation performed for the user collecting list by the user, and saving the use collecting list again after the editing operation is performed. The editing operation includes at least one of adding a playing address, deleting a playing address, modifying a playing address and clearing the user collecting list.

After the browser plug-in of the first terminal device saves the playing address of the video into the user collecting list, the method further includes:

the browser plug-in of the first terminal device obtaining a sharing operation of the user performed for the user collecting list, and sharing a playing address of a video selected by the user through the sharing operation with another user.

At block 204, the browser plug-in of the second terminal device enables the user to log on the browser plug-in of the second terminal device with the user account of the browser plug-in of the first terminal device and open the video playing window, and obtains the playing address and playing process of the video saved by the browser plug-in of the first terminal device according to the user account of the browser plug-in of the first terminal device.

In an example, when the user logs on the browser plug-in of the second terminal device with the user account of the browser plug-in of the first terminal device and opens the video playing window, the browser plug-in of the second terminal device obtains, from the cloud or the background server through the browser of the second terminal device, the playing address and playing progress of the video saved by the browser plug-in of the first terminal device.

In an example, the second terminal device may be a personal computer, a mobile phone or any mobile terminal device, which is not limited herein.

In another example, if the playing address and playing progress of the video are saved by the browser of the first terminal device, block 204 is performed by the browser of the second terminal device.

As can be seen from this block, the video playing window created by the browser plug-in of the first terminal device through the browser of the first terminal device may be opened after the user logs on the browser plug-in of another terminal device with the user account of the browser plug-in of the first terminal device. For example, in block 204 the user may log on the browser plug-in of the second terminal device and open the video playing window, thereby viewing the video continuously through different terminal devices.

At block 205, the browser plug-in of the second terminal device continues to play the video in the video playing window according to the playing address and playing process of the video.

In an example, if the user wants to continue viewing the video, the browser plug-in of the second terminal device obtains, through the browser of the second terminal device, the playing progress of the video saved by the browser plug-in of the first terminal device from the video website corresponding to the playing address. And then, the browser plug-in of the second terminal device obtains the data of the video starting from the time point corresponding to the playing progress, and plays the video starting from the time point corresponding to the playing progress, thereby implementing the continuous playing of the video. When the user wants to replay the video, the browser plug-in of the second terminal device may obtain all data of the video from the video website corresponding to the playing address through the browser of the second terminal device, and play the video in the video playing window.

In another example, if the playing address and playing progress of the video is saved by the browser of the first terminal device, block is performed by the browser of the second terminal device.

At block 206, the browser plug-in of the second terminal device saves the playing address of the video in a user collecting list. The user collecting list saves playing addresses of all videos viewed by the user.

In another example, this block may be performed after block 202.

In an example, the user may also log on the browser plug-in of the second terminal device with the user account of the browser plug-in of the first terminal device, and perform an editing operation for the user collecting list, such as adding a playing address, deleting a playing address, modifying a playing address or clearing the user collecting list. When obtaining the editing operation performed for the user collecting list by the user, the browser plug-in of the second terminal device saves the user collecting list again.

It should be noted that, the user may share the videos in the user collecting list with other users or buddies. The user may share the playing addresses of all videos in the user collecting list with other users or buddies, or share the playing addresses of partial videos in the user collecting list with other users or buddies. When obtaining a sharing operation performed for the user collecting list by the user, the browser plug-in of the second terminal device shares the playing address of a video selected by the user through the sharing operation with other users.

As can be seen from the method provided by the embodiments of the present invention, the playing address and playing progress of the video are saved by the client of the first terminal device, and thus the client of the second terminal device may continue to play the video according to the playing address and playing progress of the video after the user logs on the client of the second terminal device with the user account of the client of the first terminal device. In this way, the video collected or saved through a terminal device can be played through another terminal device. Accordingly, the user may view the video of any video website through different terminal devices, thereby improving the experiences of the user.

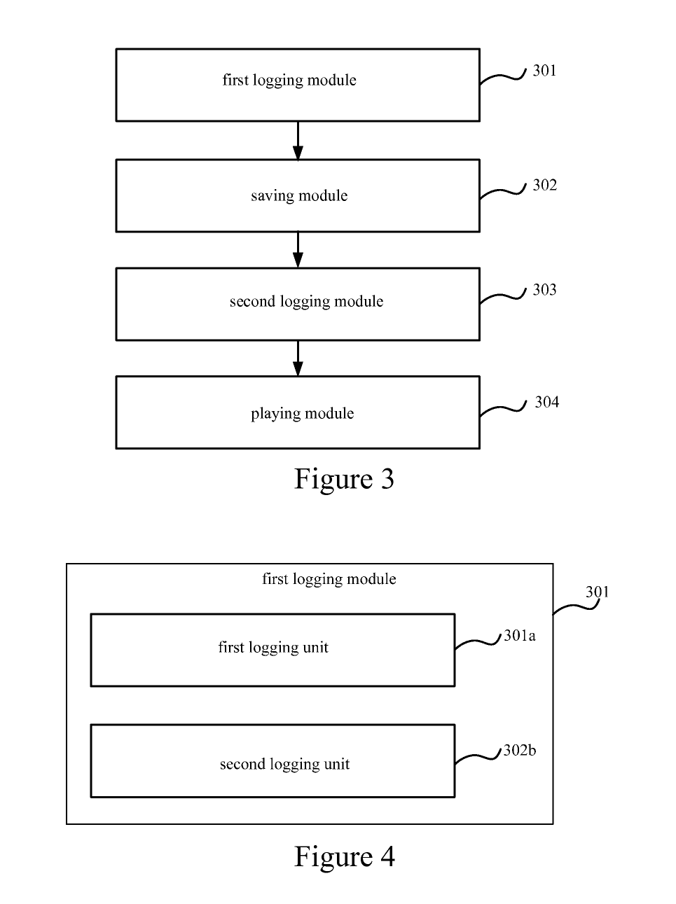

FIG. 3 is a schematic diagram illustrating the structure of a video playing apparatus according to an embodiment of the present invention. As shown in FIG. 3, the apparatus includes a first logging module 301, a saving module 302, a second logging module 303 and a playing module 304.

The first logging module 301 is configured to enable a user to log on a client of a first terminal device with a user account of the client of the first terminal device, and play, in a video playing window, a video of a video website selected by the user.

The saving module 302 is configured to, when obtaining a terminating operation performed for the video by the user, save the user account of the client of the first terminal device as well as a playing address and playing process of the video.

The second logging module 303 is configure to enable the user to log on a client of a second terminal device with the user account of the client of the first terminal device, and obtain the playing address and play process of the video saved by the client of the first terminal device according to the user account of the client of the first terminal device.

The playing module is configured to continue to play the video in the video playing window according to the playing address and playing process of the video.

The client of the first terminal device is a browser or a browser plug-in. If the client of the first terminal device is a browser, the client of the second terminal device also is a browser. If the client of the first terminal device is a browser plug-in, the client of the second terminal device also is a browser plug-in.

In an example, the saving module 302 may save the user account of the client of the first terminal device as well as a playing address and playing process of the video at cloud.

FIG. 4 is a schematic diagram illustrating the structure of the first logging module shown in FIG. 3 according to an embodiment of the present invention. As shown in FIG. 4, the first logging module 301 includes a first logging unit 301a and a second logging unit 301b.

The first logging unit 301a is configured to create the video playing window, enable the user to log on the browser of the first terminal device with the user account of the browser of the first terminal device, and play, in the video playing window, the video of the video website selected by the user from a webpage displayed by the browser of the first terminal device. The first logging unit 301a is applicable to a case that the client of the first terminal device is a browser.

The second logging unit 301b is configured to create the video playing window through the browser of the first terminal device, enable the user to log on the browser plug-in of the first terminal device with the user account of the browser plug-in of the first terminal device, and after communicating with the browser of the first terminal device, play, in the video playing window through the browser of the first terminal device, the video of the video website selected by the user from a webpage displayed by the browser of the first terminal device. The second logging unit 301b is applicable to a case that the client of the first terminal device is a browser plug-in.

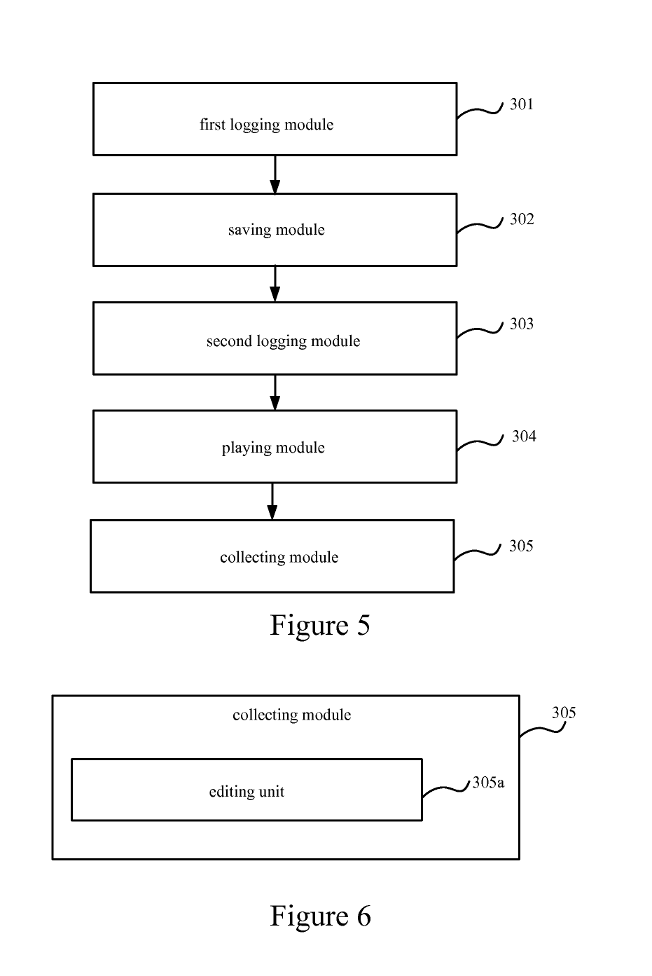

FIG. 5 is a schematic diagram illustrating the structure of a video playing apparatus according to another embodiment of the present invention. As shown in FIG. 5, the apparatus includes a first logging module 301, a saving module 302, a second logging module 303 and a playing module 304 and a saving module 305. The functions of the first logging module 301, the saving module 302, the second logging module 303 and the playing module 304 are the same as the function of these modules shown in FIG. 3, and are not illustrated herein.

The collecting module 305 is configured to save the playing address of the video in a user collecting list after the playing module 304 continues to play the video in the video playing window. The user collecting list saves playing addresses of all videos viewed by the user.

FIG. 6 is a schematic diagram illustrating the structure of a collecting module shown in FIG. 5 according to an embodiment of the present invention. As shown in FIG. 6, the collecting module 305 includes an editing unit 305a.

The editing unit 305a is configured to, after the collecting module 305 saves the playing address of the video into the user collecting list, obtain an editing operation performed for the user collecting list by the user, and save the use collecting list again after the editing operation is performed. The editing operation includes at least one of adding a playing address, deleting a playing address, modifying a playing address and clearing the user collecting list.

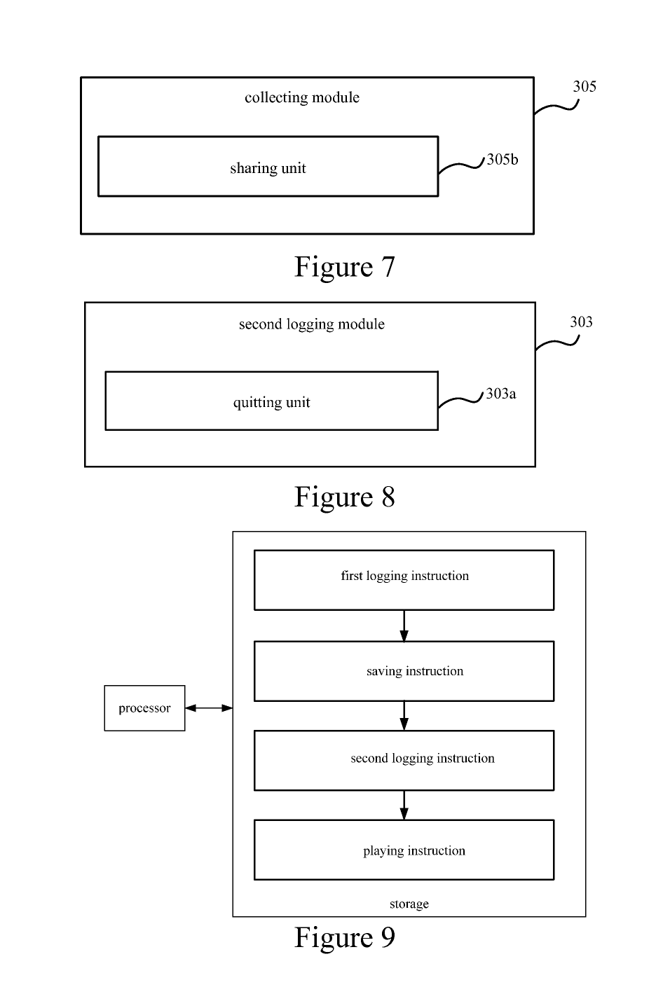

FIG. 7 is a schematic diagram illustrating the structure of the collecting module shown in FIG. 5 according to another embodiment of the present invention. As shown in FIG. 7, the collecting module 305 includes a sharing module 305b.

The sharing module 305b is configured to, after the collecting module 305 saves the playing address of the video into the user collecting list, obtain a sharing operation performed for the user collecting list by the user, and sharing a playing address of a video selected by the user through the sharing operation with another user.

FIG. 8 is a schematic diagram illustrating the structure of a second logging module shown in FIG. 3 according to an embodiment of the present invention. As shown in FIG. 8, the second logging module 303 includes a quitting unit 303a.

The quitting unit 303a is configured to, when obtaining an operation of quitting the video playing window, save the user account of the client of the first terminal device as well as the playing address and playing process of the video.

As can be seen from the apparatus provided by the embodiments of the present invention, the playing address and playing progress of the video are saved by the client of the first terminal device, and thus the client of the second terminal device may continue to play the video according to the playing address and playing progress of the video after the user logs on the client of the second terminal device with the user account of the client of the first terminal device. In this way, the video collected or saved through a terminal device can be played through another terminal device. Accordingly, the user may view the video of any video website through different terminal devices, thereby improving the experiences of the user.

It should be noted that, the module structure and functions of the video playing apparatus are illustrated as an example. In a practical application, the above functions may be implemented by different modules. That is, the video playing apparatus may include different modules for implementing all or part of above functions. In addition, the implementation of the video playing apparatus may refer to the method examples, and is not illustrated in detail herein.

FIG. 9 is a schematic diagram illustrating a video playing apparatus according to another example of the present disclosure. As shown in FIG. 9, the apparatus at least includes storage and a processor communicated with the storage. The storage includes a first logging instruction, a saving instruction, a second logging instruction and a playing instruction which can be executed by the processor.

The first logging instruction is configured to enable a user to log on a client of a first terminal device with a user account of the client of the first terminal device, and play, in a video playing window, a video of a video website selected by the user.

the saving instruction is configured to, when obtaining a terminating operation performed for the video by the user, save the user account of the client of the first terminal device as well as a playing address and playing process of the video;

a second logging instruction is configure to enable the user to log on a client of a second terminal device with the user account of the client of the first terminal device, and obtain the playing address and play process of the video saved by the client of the first terminal device according to the user account of the client of the first terminal device; and

a playing instruction is configured to continue to play the video in the video playing window according to the playing address and playing process of the video.

In an example, the first logging instruction includes:

a first logging sub-instruction, configured to create the video playing window, enable the user to log on the browser of the first terminal device with the user account of the browser of the first terminal device, and play, in the video playing window, the video of the video website selected by the user from a webpage displayed by the browser of the first terminal device; and

a second logging sub-instruction, configured to create the video playing window through the browser of the first terminal device, enable the user to log on the browser plug-in of the first terminal device with the user account of the browser plug-in of the first terminal device, and after communicating with the browser of the first terminal device, play, in the video playing window through the browser of the first terminal device, the video of the video website selected by the user from a webpage displayed by the browser of the first terminal device.

In an example, the apparatus further includes:

a collecting instruction, configured to save the playing address of the video in a user collecting list after the playing instruction continues to play the video in the video playing window, wherein the user collecting list saves playing addresses of all videos viewed by the user.

In an example, the collecting instruction includes:

an editing instruction, configured to, after the collecting instruction saves the playing address of the video into the user collecting list, obtain an editing operation performed for the user collecting list by the user, and save the use collecting list again after the editing operation is performed, wherein the editing operation includes at least one of adding a playing address, deleting a playing address, modifying a playing address and clearing the user collecting list.

In an example, the collecting instruction includes:

a sharing instruction, configured to, after the collecting instruction saves the playing address of the video into the user collecting list, obtain a sharing operation performed for the user collecting list by the user, and sharing a playing address of a video selected by the user through the sharing operation with another user.

In an example, the second logging instruction includes:

a quitting instruction, configured to, when obtaining an operation of quitting the video playing window, save the user account of the client of the first terminal device as well as the playing address and playing process of the video.

Those skilled in the art can understand that all or part of processes in the method provided by the embodiments of the present invention can be implemented by hardware, or can be implemented through instructing related hardware by a program. The program may be stored in a computer readable memory. The memory includes a ROM, a disk, a Compact Disc (CD) and so on.

The foregoing is some embodiments of the present invention and is not used to limit the protection scope of the present invention. Any modification, equivalent substitution and improvement without departing from the principle of the present invention are within the protection scope of the present invention.

What is claimed is:

1. A video playing method, comprising:
enabling, by a client of a first terminal device, a user to log on the client of the first terminal device with a user account of the client of the first terminal device, and playing, in a video playing window, a video of a video website selected by the user;
when obtaining a terminating operation performed for the video by the user, saving, by the client of the first terminal device, the user account of the client of the first terminal device as well as a playing address and playing process of the video;
enabling, by a client of a second terminal device, the user to log on the client of the second terminal device with the user account of the client of the first terminal device, and obtaining the playing address and playing process of the video saved by the client of the first terminal device according to the user account of the client of the first terminal device; and
continuing, by the client of the second terminal device, to play the video in the video playing window according to the playing address and playing process of the video.

2. The method of claim 1, wherein
if the client of the first terminal device is a browser, the enabling, by the client of the first terminal device, the user to log on the client of the first terminal device with the user account of the client of the first terminal device, and playing, in the video playing window, the video of the video website selected by the user comprises:
creating, by the browser of the first terminal device, the video playing window, enabling the user to log on the browser of the first terminal device with the user account of the browser of the first terminal device, and playing, in the video playing window, the video of the video website selected by the user from a webpage displayed by the browser of the first terminal device;
if the client of the first terminal device is a browser plug-in, the enabling, by the client of the first terminal device, the user to log on the client of the first terminal device with the user account of the client of the first terminal device, and playing, in the video playing window, the video of the video website selected by the user includes:
creating, by the browser plug-in of the first terminal device, the video playing window through the browser of the first terminal device, enabling the user to log on the browser plug-in of the first terminal device with the user account of the browser plug-in of the first terminal device, and after communicating with the browser of the first terminal device, playing, in the video playing window through the browser of the first terminal device, the video of the video website selected by the user from a webpage displayed by the browser of the first terminal device.

3. The method of claim 1, after the client of the second terminal device continues to play the video in the video playing window according to the playing address and playing process of the video, further comprising:
saving, by the client of the second terminal device, the playing address of the video in a user collecting list, wherein the user collecting list saves playing addresses of all videos viewed by the user.

4. The method of claim 3, after the client of the second terminal device saves the playing address of the video into the user collecting list, further comprising:
obtaining, by the client of the second terminal device, an editing operation performed for the user collecting list by the user, and saving the use collecting list again after the editing operation is performed, wherein the editing operation comprises at least one of adding a playing address, deleting a playing address, modifying a playing address and clearing the user collecting list.

5. The method of claim 3, after the client of the second terminal device saves the playing address of the video into the user collecting list, further comprising:
obtaining, by the client of the second terminal device, a sharing operation of the user performed for the user collecting list, and sharing a playing address of a video selected by the user through the sharing operation of the user with another user.

6. The method of claim 1, wherein the terminating operation at least comprises an operation of quitting the video playing window, and
when obtaining the operation of quitting the video playing window, saving, by the client of the first terminal device, the user account of the client of the first terminal device as well as the playing address and playing process of the video.

7. A video playing apparatus, comprising a first logging module, a saving module, a second logging module and a playing module, wherein
the first logging module is configured to enable a user to log on a client of a first terminal device with a user account of the client of the first terminal device, and play, in a video playing window, a video of a video website selected by the user.
the saving module is configured to, when obtaining a terminating operation performed for the video by the user, save the user account of the client of the first terminal device as well as a playing address and playing process of the video;
a second logging module is configure to enable the user to log on a client of a second terminal device with the user account of the client of the first terminal device, and obtain the playing address and play process of the video saved by the client of the first terminal device according to the user account of the client of the first terminal device; and
a playing module is configured to continue to play the video in the video playing window according to the playing address and playing process of the video.

8. The apparatus of claim 7, wherein the first logging module comprises:
a first logging unit, configured to create the video playing window, enable the user to log on the browser of the first terminal device with the user account of the browser of the first terminal device, and play, in the video playing window, the video of the video website selected by the user from a webpage displayed by the browser of the first terminal device; and
a second logging unit, configured to create the video playing window through the browser of the first terminal device, enable the user to log on the browser plug-in of the first terminal device with the user account of the browser plug-in of the first terminal device, and after communicating with the browser of the first terminal device, play, in the video playing window through the browser of the first terminal device, the video of the video website selected by the user from a webpage displayed by the browser of the first terminal device.

9. The apparatus of claim 7, further comprising:
a collecting module, configured to save the playing address of the video in a user collecting list after the playing module continues to play the video in the video playing window, wherein the user collecting list saves playing addresses of all videos viewed by the user.

10. The apparatus of claim 9, wherein the collecting module comprises:
an editing unit, configured to, after the collecting module saves the playing address of the video into the user collecting list, obtain an editing operation performed for the user collecting list by the user, and save the use collecting list again after the editing operation is performed, wherein the editing operation comprises at least one of adding a playing address, deleting a playing address, modifying a playing address and clearing the user collecting list.

11. The apparatus of claim 9, wherein the collecting module comprises:
a sharing module, configured to, after the collecting module saves the playing address of the video into the user collecting list, obtain a sharing operation performed for the user collecting list by the user, and sharing a playing address of a video selected by the user through the sharing operation with another user.

12. The apparatus of claim 7, wherein the second logging module comprises:
a quitting unit, configured to, when obtaining an operation of quitting the video playing window, save the user account of the client of the first terminal device as well as the playing address and playing process of the video.
